(19) United States
(12) Patent Application Publication
(10) Pub. No.: US 2007/0239747 A1
(43) Pub. Date: Oct. 11, 2007

(54) Methods, systems, and computer program products for providing read ahead and caching in an information lifecycle management system

(75) Inventor: Timothy C. Pepper, Tigard, OR (US)

Correspondence Address: CANTOR COLBURN LLP - IBM TUSCON DIVISION, 55 GRIFFIN ROAD SOUTH, BLOOMFIELD, CT, 06002, US

(73) Assignee: INTERNATIONAL BUSINESS MACHINES CORPORATION, ARMONK, NY (US)

(21) Appl. No.: 11/392,295

(22) Filed: Mar. 29, 2006

(51) Int. Cl. G06F 7/00

(52) U.S. Cl. 707/101

(57) ABSTRACT

A method, system, and computer program product for providing read ahead and caching in an information lifecycle management system of a host system is provided. The method includes monitoring data access activities performed by requesting entities of the host system. The method also includes building an index of sampled data accesses that include metadata of requests for data access and resulting data content and utilizing the index of sampled data accesses to determine data access trends based upon results of the monitoring. The method further includes determining correlations between multiple accesses' metadata and the resulting data content, initiating a search of multi-tiered storage devices of the host system for other content, the other content relating to the content sampled in the index, and migrating data resulting from the search to a high tier storage location of the host system in anticipation of future demand for the data.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to information management systems, and particularly to methods, systems, and computer program products for providing read ahead and caching in an information lifecycle management system.

2. Description of Background

Before our invention, data storage management solutions enabled automated tools, such as information lifecycle management (ILM) systems to determine placement and migration of data using, e.g., policy-based metrics, such as the age of a file, the size of a document, etc. Information lifecycle management refers to a process for managing information throughout its lifecycle in a manner that optimizes storage and access at the lowest cost. An underlying premise relied upon by ILM is that most data written to a storage system is never, or rarely, read again. Important information, e.g., data that is frequently accessed, is typically placed in high tier storage that provides easy and quick retrieval, while other information is placed in slower, or low tier storage, which is generally less expensive and thus, provides cost savings.

While current systems provide some benefit in leveraging quantities of data against the costs of storage systems, these systems do not anticipate which currently stored data (in high tier or low tier storage) may become important at a future time. Accordingly, because information that has been determined to be of low importance (i.e., based upon policies implemented via the ILM), and stored in low tier storage, may become important at some future time, it is desirable to provide a method in which information can be migrated to higher tier storage in anticipation of identified or speculated demand or interest.

### SUMMARY OF THE INVENTION

The shortcomings of the prior art are overcome and additional advantages are provided through the provision of methods, systems, and computer program products for providing read ahead and caching in an information lifecycle management system. The method includes monitoring data access activities performed by requesting entities of the host system. The method also includes building an index of sampled data accesses that include metadata of requests for data access and resulting data content and utilizing the index of sampled data accesses to determine data access trends based upon results of the monitoring. The method further includes determining correlations between multiple accesses' metadata and the resulting data content, initiating a search of multi-tiered storage devices of the host system for other content, the other content relating to the content sampled in the index, and migrating data resulting from the search to a high tier storage location of the host system in anticipation of future demand for the data.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution in which information is migrated to higher tier storage in anticipation of an identified or speculative demand or interest.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a block diagram of a system upon which the read ahead/caching (RA/C) activities may be implemented in exemplary embodiments; and

FIG. 2 illustrates one example of flow diagram describing a process for implementing the RA/C activities in exemplary embodiments.

The detailed description explains the preferred embodiments of the invention, together with advantages and features, by way of example with reference to the drawings.

### DETAILED DESCRIPTION OF THE INVENTION

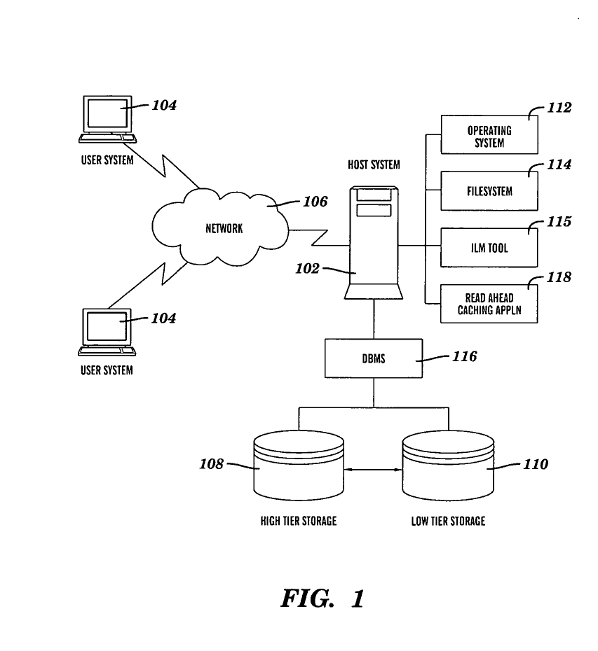

Turning now to the drawings in greater detail, it will be seen that in FIG. 1 there is a block diagram of a system upon which the read ahead/caching (RA/C) activities may be implemented. The system 100 of FIG. 1 includes a host system 102 in communication with user systems 104 over a network 106. Host system 102 may be a high speed processing device (e.g., a mainframe computer) that handles large volumes of processing requests from user systems 104. In exemplary embodiments, host system 102 functions as an applications server, web server, and database management server. User systems 104 may comprise desktop or general-purpose computer devices that generate data and processing requests, such as requests to utilize applications and perform searches. For example, user systems 104 may request web pages, documents, and files that are stored in various storage systems. While only a single host system 102 is shown in the system 100 of FIG. 1, it will be understood that multiple host systems may be implemented, each in communication with one another via direct coupling or via one or more networks. For example, multiple host systems may be interconnected through a distributed network architecture. The single host system 102 may also represent a cluster of hosts accessing a common data store, e.g., via a clustered filesystem which is backed by tiered storage (e.g., storage devices 108, 110).

Network 106 may be any type of communications network known in the art. For example, network 106 may be an intranet, extranet, or an internetwork, such as the Internet, or a combination thereof. Network 106 may be a wireless or wireline network.

Host system 102 is also in communication with storage devices 108 and 110. Storage device 108 refers to high tier storage and may comprise cache memory that is internal to host system 102, or main memory. In exemplary embodiments, storage device 108 is internal to the host system 102. The high tier storage of device 108 is configured such that requests for the data stored therein are processed more quickly than that of lower tier storage elements. Application data provides one example of what may be ideally stored in high tier storage since it is frequently accessed.

Storage device 110 refers to low tier storage and may comprise a secondary storage element, e.g., hard disk drive, tape, or a storage subsystem that is external to host system 102. Types of data that may be stored in low tier storage include archive data that are infrequently accessed. It will be understood that the two tiers of storage shown in FIG. 1 are provided for purposes of simplification and ease of explanation and are not to be construed as limiting in scope. To the contrary, there may be multiple levels of tiered storage utilized by the host system 102 in order to realize the advantages of the exemplary embodiments. Thus, there may be levels of storage between the high tier storage and the low tier storage as desired by the enterprise implementing the host system 102.

In exemplary embodiments, host system 102 executes various applications, including an operating system 112, an information lifecycle management (ILM) tool 115, and a database management system 116. Operating system 112 (and ILM tool 115) utilize a filesystem 114 to organize and track information stored in storage devices 108 and 110. ILM tool 115 facilitates data storage management by determining placement and migration of data using, e.g., policy-based metrics, such as the age of a file, the size of a document, etc. The ILM tool 115 updates filesystem 114 with the placement locations (i.e., storage locations) of the data. Other applications, e.g., business applications, a web server, etc., may also be implemented by host system 102 as dictated by the needs of the enterprise of the host system 102.

The host system 102 also executes one or more applications for implementing the RA/C activities described herein. These one or more applications are collectively referred to as a read ahead/caching (RA/C) application 118. The RA/C application 118 includes logic for monitoring data access of storage devices 108, 110 and for performing trend analyses of the data accesses. The monitoring may include sampling the accesses' metadata and resulting data content. In exemplary embodiments, RA/C application 118 maintains an index of the metadata and content. This index is described further herein. The RA/C application 118 may include a user interface for enabling system users to select policies for determining what level of activity constitutes a trend. The RA/C application 118 may be configured to operate or perform at least a portion of its processing out-of-band in order to avoid interference with the system's performance. Out-of-band processing refers to processes performed during idle or slow periods noted for the system. The out-of-band processing may happen not only during idle or slow periods, but may also be completely offloaded to a different machine or machines, possibly dedicated to the task of monitoring access and doing trend analysis. This RA/C engine could also coalesce trend data from multiple hosts' accesses.

As indicated above, the RA/C application 118 enables information in storage devices 108, 110 to be migrated to alternative storage locations (e.g., from 108 to 110 and vice versa). The migration to higher tier storage is facilitated in anticipation of an identified or speculative demand or interest as described herein. While the functionality of the RA/C application 118 is shown and described as a separate component from the ILM tool 115, it will be understood by those skilled in the art that the features of both the ILM tool 115 and the RA/C application 118 may be integrated and form a single application.

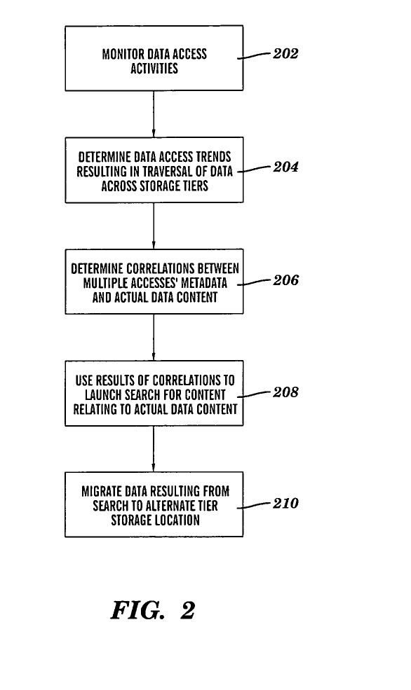

Turning now to FIG. 2, a process for implementing the RA/C activities will now be described in accordance with exemplary embodiments. At step 202, the RA/C application 118 monitors data access activities performed by requesting entities, such as user systems 104. The monitoring may be implemented by sampling data accesses at designated time intervals. The monitoring may also apply to the data placement and migration activities performed by ILM tool 115 with respect to the placement and migration of data. The RA/C application 188 builds an index of sampled data, which includes metadata associated with a data access request and the actual physical data or content resulting from the request.

At step 204, the RA/C application 118 determines any trends or patterns resulting from the monitoring (e.g., trends relating to data access activities that cause the traversal of data across storage tiers (e.g., from high tier storage 108 to low tier storage 110 or vice versa)). The RA/C application 118 utilizes the index created in step 202 in performing this analysis. As indicated above, the policies for determining what constitutes a trend may be established by a user of the RA/C application 118. For example, the number of data accesses of a particular document within a specified period of time may be designated as a trend. In addition, the number of queries containing a particular word or phrase may be the subject of a trend.

At step 206, the RA/C application 118 determines any correlations existing between multiple accesses' metadata and actual data content (e.g., accessed data from storage devices 108, 110).

At step 208, the RA/C application 118 uses the results of the correlations determined at step 206 to launch a search of storage devices 108 and 110 for any content that relates to the accessed content (i.e., the sampled data). The search is performed in order to identify any documents, files, etc., that may be of interest and, thus, subject to demand in the near future.

At step 210, the RA/C application 118 migrates data resulting from the search performed in step 208 to a higher tier storage location (e.g., storage device 108); that is, if it does not already reside there. Thus, the RA/C application 118 anticipates what data may be anticipated in the future based upon current data access trends and ensures that the anticipated data is readily available in high tier storage. For example, in a litigation environment, a search for information may turn up old case files that may be relevant to a current litigation (e.g., the subject of the old case files share similar characteristics to those of the current litigation). The old case files are stored in low tier storage by virtue of their age, but the RA/C application 118 overrides the policies (i.e., age policy) of the ILM tool 115 and brings the old case files to higher tier storage in anticipation of a future interest (i.e., the new or current litigation matter). Note that the old case files were not the subject of a search by a system user (e.g., user systems 104). Conversely, the RA/C application 118 may determine as a result of a search that items in high tier storage should be migrated to lower tier storage. The decision to migrate data resulting from the search may be balanced against various criteria, e.g., policies that determine how much of a resource may be consumed by cache data as opposed to “real”, policy non-overridden data. Further, there may be a policy for determining how to select the particular cache data for relegation. These policies may be factored into the ultimate decisions regarding data migration among tiered storage devices. Thus, a final determination of migration may be made for data content (i.e., the data content resulting from the search processes described above) based upon these existing policies in conjunction with the search results.

The RA/C application 118 performs the searches and subsequent migration out-of-band so that valuable resources are not interrupted or impacted by these activities.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for providing read ahead and caching in an information lifecycle management system of a host system, comprising:
monitoring data access activities performed by requesting entities of the host system;
building an index of sampled data accesses that include metadata of requests for data access and resulting data content;
utilizing the index of sampled data accesses to determine data access trends based upon results of the monitoring;
determining correlations between multiple accesses' metadata and the resulting data content;
initiating a search of multi-tiered storage devices of the host system for other content, the other content relating to the content sampled in the index; and
migrating data resulting from the search to a high tier storage location of the host system in anticipation of future demand for the data; wherein a decision to migrate data factors in existing cache policies.

2. The method of claim 1, wherein determining the data access trends based upon results of the monitoring is performed out-of-band.

3. The method of claim 1, wherein the high tier storage location comprises a storage location in main memory of the host system.

4. The method of claim 1, wherein the migrating data resulting from the search overrides a policy implemented by the information lifecycle management system specifying placement of the data.

5. A system for providing read ahead and caching in an information lifecycle management system, comprising:
a host system executing a lifecycle management tool;
a high tier storage device in communication with the host system;
a low tier storage device in communication with the host system; and
a read ahead caching application executing on the host system, the read ahead caching application performing:
monitoring data access activities performed by requesting entities of the host system;
building an index of sampled data accesses that include metadata of requests for data access and resulting content;
utilizing the index of sampled data accesses to determine data access trends based upon results of the monitoring;
determining correlations between multiple accesses' metadata and the resulting data content;
initiating a search of the low tier storage devices of the host system for other content, the other content relating to the content sampled in the index; and
migrating data resulting from the search to the high tier storage location of the host system in anticipation of future demand for the data.

6. The system of claim 5, wherein determining the data access trends based upon results of the monitoring is performed out-of-band.

7. The system of claim 5, wherein the high tier storage location comprises a storage location in main memory of the host system.

8. The system of claim 5, wherein the migrating data resulting from the search overrides a policy implemented by the information lifecycle management system specifying placement of the data.

9. A computer program product for providing read ahead and caching in an information lifecycle management system of a host system, the computer program product including instructions for implementing a method, comprising:
monitoring data access activities performed by requesting entities of the host system;
building an index of sampled data accesses that include metadata of requests for data access and resulting data content;
utilizing the index of sampled data accesses to determine data access trends based upon results of the monitoring;
determining correlations between multiple accesses' metadata and the resulting data content;
initiating a search of multi-tiered storage devices of the host system for other content, the other content relating to the content sampled in the index; and
migrating data resulting from the search to a high tier storage location of the host system in anticipation of future demand for the data; wherein a decision to migrate data factors in existing cache policies.

10. The computer program product of claim 9, wherein determining the data access trends based upon results of the monitoring is performed out-of-band.

11. The computer program product of claim 9, wherein the high tier storage location comprises a storage location in main memory of the host system.

12. The computer program product of claim 9, wherein the migrating data resulting from the search overrides a policy implemented by the information lifecycle management system specifying placement of the data.
